(19) United States
(12) Patent Application Publication
(10) Pub. No.: US 2024/0146663 A1
(43) Pub. Date: May 2, 2024

(54) GATEWAY DEVICE AND METHOD THEREFOR, MEDIUM AND APPLICATION PRODUCT

(71) Applicant: ARRIS Enterprises LLC, Suwanee, GA (US)

(72) Inventors: Linzhou CAI, Shenzhen (CN); Lijie NIU, Shenzhen (CN); Rui CHEN, Shenzhen (CN); Shenxia TAN, Shenzhen (CN); Fen HUANG, Shenzhen (CN)

(21) Appl. No.: 18/381,712

(22) Filed: Oct. 19, 2023

(30) Foreign Application Priority Data
Oct. 26, 2022 (CN) 202211317218.0

(51) Int. Cl. H04L 47/36; H04L 69/22

(52) U.S. Cl. CPC H04L 47/36; H04L 69/22

(57) ABSTRACT

The present disclosure relates to a gateway device and a method therefor, a medium and an application product. The gateway device includes: a processor; and a memory coupled to the processor and stored with instructions that, when executed by the processor, cause the gateway device to perform the following operations: during connection of the gateway device to an external network via a mobile network: receiving, from a first networked device, a data packet to be forwarded to the second networked device via the gateway device; determining that the data packet has a data volume greater than a threshold data volume; and intercepting the data packet.

### TECHNICAL FIELD

The present disclosure relates to a gateway device, and specifically relates to interception of data packets by the gateway device.

### BACKGROUND ART

A gateway device on a local area network is typically connected to an external network via a fixed network, such as the Internet. The fixed network refers to the propagation of network signals via fixed, preset transmission media (such as optical fibers, telephone lines, copper cables or other special network cables). Correspondingly, a mobile terminal device, such as a mobile phone, may use a mobile network to connect to the Internet. Herein, the mobile network refers to a network provided by a mobile communications operator based on cellular mobile communications technologies. With the rapid development of mobile communications technologies, the mobile network has significantly improved bandwidth and connection stability, but is still slightly underperforming compared to the fixed network. In addition, traffic fees of the mobile network are more expensive than the fixed network.

### SUMMARY OF THE INVENTION

In some cases, for example, when a fixed network is not available, it may be desirable for a gateway device to use a mobile network as an alternative for connecting to an external network. However, when a user wishes to send or receive a large data volume through the gateway device, use of the mobile network will incur high traffic fees. Especially if the gateway device transparently switches connection to the external network via the fixed network to via the mobile network, the user will generate large traffic overheads without notice. In addition, due to bandwidth limitations of the mobile network, network experience of other users within the same network may be deteriorated when the users transmit a large number of packets of data via the mobile network. Therefore, it is desirable that there is a technology that enables the gateway device to provide continuous network connection to the external network, which also avoids causing the user to incur high mobile network traffic fees and/or interfere with network activities of other users within the same network of the shared gateway device.

The present disclosure provides a gateway device and a method therefor, a medium and a computer application product, which can block certain data packets with a relatively large data volume when the gateway device is connected to an external network through a mobile network, thereby reducing traffic fees and taking into account network experience of different users.

According to a first aspect of the present disclosure, a gateway device is provided. The gateway device includes: a processor; and a memory coupled to the processor and stored with instructions that, when executed by the processor, cause the gateway device to perform the following operations: during a connection of the gateway device to an external network via a mobile network: receiving, from a first networked device, a data packet to be forwarded to the second networked device via the gateway device; determining that the data packet has a data volume greater than a threshold data volume; and intercepting the data packet.

In some embodiments, the instructions further cause the gateway device to perform the following operation: switching the connection of the gateway device to the external network via a fixed network to via the mobile network.

In some embodiments, the instructions further cause the gateway device to perform the following operation: switching the connection of the gateway device to the external network via the mobile network to via a fixed network.

In some embodiments, the instructions further cause the gateway device to perform the following operation: during the connection of the gateway device to an external network via a fixed network: receiving a second data packet to be forwarded via the gateway device; and forgoing intercepting the second data packet.

In some embodiments, the instructions further cause the gateway device to perform the following operation: in response to the gateway device switching the connection of the gateway device to the external network to via the fixed network, sending an allow signal to the first networked device.

In some embodiments, the determining that the data packet has a data volume greater than a threshold data volume includes: parsing a header of the data packet to determine a network protocol used to transmit the data packet; and determining that the network protocol is one of a predefined group of network protocols, where each network protocol in the predefined group of network protocols indicates that a data packet transmitted using the network protocol has a data volume greater than the threshold data volume.

In some embodiments, the predefined group of network protocols is an application layer protocol.

In some embodiments, the predefined set of network protocols includes at least one of a protocol for file transfer, a protocol for session establishment, a peer-to-peer protocol, or an application layer streaming protocol.

In some embodiments, the determining that the data packet has a data volume greater than a threshold data volume comprises: parsing a header of the data packet to determine a source MAC address of the data packet; and determining that the source MAC address is one of a MAC address blacklist or determining that the source MAC address is not one of a MAC address whitelist, wherein the MAC address blacklist and the MAC address whitelist are obtained by categorizing MAC addresses of networked devices based on a comparison of data volumes of data packets transmitted by the networked devices with the threshold data volume.

In some embodiments, the determining that the data packet has a data volume greater than a threshold data volume and the intercepting the data packet are performed in response to determining that the gateway device is configured to enable an application layer intercepting function.

In some embodiments, the instructions further cause the gateway device to perform the following operation: configuring the gateway device to enable the application layer interception function in response to user input.

In some embodiments, the instructions further cause the gateway device to perform the following operation: in response to determining that the gateway device is configured to disable the application layer interception function, forgoing execution of the determining that the data packet has an data volume greater than a threshold data volume and the intercepting the data packet.

In some embodiments, the intercepting the data packet includes: returning a rejection signal to the first networked device.

According to a second aspect of the present disclosure, a method for a gateway device is provided. The method may include: during a connection of the gateway device to an external network via a mobile network: receiving, from a first networked device, a data packet to be forwarded to the second networked device via the gateway device; determining that the data packet has a data volume greater than a threshold data volume; and intercepting the data packet.

In some embodiments, the method further includes switching the connection of the gateway device to the external network via a fixed network to via the mobile network.

In some embodiments, the method further includes switching the connection of the gateway device to the external network via the mobile network to via a fixed network.

In some embodiments, the method further includes: during the connection of the gateway device to an external network via a fixed network: receiving a second data packet to be forwarded via the gateway device; and forgoing intercepting the second data packet.

In some embodiments, the determining that the data packet has a data volume greater than a threshold data volume includes: parsing a header of the data packet to determine a network protocol used to transmit the data packet; and determining that the network protocol is one of a predefined group of network protocols, where each network protocol in the predefined group of network protocols indicates that a data packet transmitted using the network protocol has a data volume greater than the threshold data volume.

In some embodiments, the determining that the data packet has a data volume greater than a threshold data volume comprises: parsing a header of the data packet to determine a source MAC address of the data packet; and determining that the source MAC address is one of a preset MAC address blacklist or determining that the source MAC address is not one of a preset MAC address whitelist, wherein the MAC address blacklist and the MAC address whitelist are obtained by categorizing MAC addresses of networked devices based on a comparison of data volumes of data packets transmitted by the networked devices with the threshold data volume.

In some embodiments, the determining that the data packet has a data volume greater than a threshold data volume and the intercepting the data packet are performed in response to determining that the gateway device is configured to enable an application layer intercepting function.

In some embodiments, the method further includes configuring the gateway device to enable the application layer interception function in response to user input.

In some embodiments, the intercepting the data packet includes: returning a rejection signal to the first networked device.

According to a third aspect of the present disclosure, a non-transitory computer-readable medium to be used together with a processor of a gateway device is provided. The non-transitory computer-readable medium has instructions stored therein, and the instructions execute at least the method mentioned in the second aspect when executed by the processor.

According to a fourth aspect of the present disclosure, a computer application product, including computer instructions, is provided, where the computer instructions implement the method mentioned in the second aspect when executed by a processor of a gateway device.

### BRIEF DESCRIPTION OF THE ATTACHED DRAWINGS

For a better understanding of the present disclosure and to show how to realize the present disclosure, examples are herein described with reference to the attached drawings, in which:

FIG. 1 is a schematic diagram of a network topology in which embodiments of the present disclosure are located;

FIG. 2 is a block diagram showing a configuration of a gateway device according to an embodiment of the present disclosure;

FIG. 3 is an exemplary flowchart of a method for a gateway device according to an embodiment of the present disclosure;

FIG. 4 is an exemplary flowchart of a method for a gateway device according to an embodiment of the present disclosure; and

FIG. 5 is a schematic diagram of configuring a gateway device according to an embodiment of the present disclosure.

It should be noted that throughout the attached drawings, similar reference numerals and signs refer to corresponding parts.

### SPECIFIC EMBODIMENTS

The following detailed description is made with reference to the attached drawings, and the following detailed description is provided to facilitate comprehensive understanding of various exemplary embodiments of the present disclosure. The following description includes various details for facilitation of understanding. However, these details are merely considered as examples, not for limiting the present disclosure. The present disclosure is defined by the attached Claims and their equivalents. The words and phrases used in the following description are only used to enable a clear and consistent understanding of the present disclosure. In the present disclosure, limitations such as “first” and “second” are only for the ease of differentiation and unless otherwise specified, do not represent the sequence between the described elements. In addition, for clarity and brevity, descriptions of well-known structures, functions, and configurations may be omitted. Those of ordinary skill in the art will realize that various changes and modifications can be made to the examples described in the present specification without departing from the gist and scope of the present disclosure.

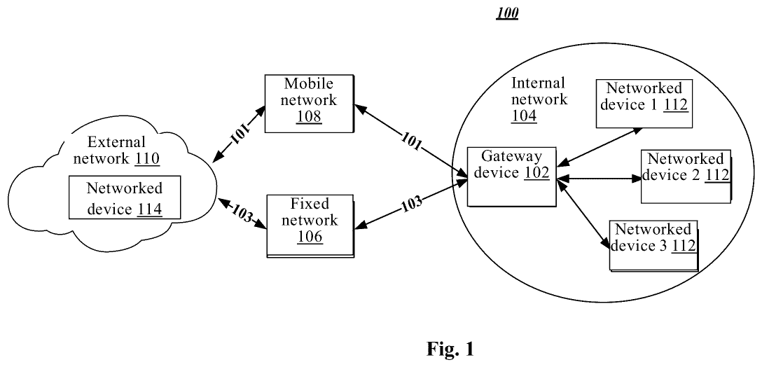

FIG. 1 is a schematic diagram of a network topology 100 in which embodiments of the present disclosure are located. This topology includes an internal network 104, a fixed network 106, a mobile network 108, and an external network 110. Here, “internal” and “external” are relative to the gateway device 102. The internal network 104 may be a wired local area network or a wireless local area network (such as IEEE 802.11 Wi-Fi). For example, the external network 106 may be a wide area network (WAN) (such as the Internet or a private IP network) or a mobile communication core network. The gateway device 102 provides an interface for external communication by the internal network 104. In the internal network 104, one or more networked devices 112 transmit and receive packets externally via the gateway device 102. That is, the gateway device 102 may provide a network access function to the external network to the networked device 112 connected to the gateway device 102 by wired or wireless means.

In some embodiments, the gateway device 102 may connect to the external network 110 only through the mobile network 108 (i.e., via a path 101). In this case, the fixed network 106 in the network topology 100 is omittable. The mobile network 108 may be a mobile communications network based on cellular communications technologies. For example, the mobile network 108 may be a network based on at least one technology such as GSM, CDMA 2000, UMTS (WCDMA), LTE, Advanced LTE (LTE-A), LAA/LTE-U, and 5G NR. In general, the mobile network 108 may be provided by a mobile network operator.

In some embodiments, the gateway device 102 may be connected to the external network 110 through the mobile network 108 (i.e., via the path 101) and the fixed network 106 (i.e., via a path 103), respectively. The fixed network 106 may propagate network signals via fixed, preset transmission media (such as optical fibers, telephone lines, copper wires, or other dedicated network cables).

In some embodiments, the gateway device 102 may switch between connecting to the external network 110 via the mobile network 108 and connecting to the external network 110 via the fixed network 106. For example, the gateway device 102 may be connected to the external network mainly via the fixed network 106, and switching to the mobile network 108 is performed automatically or upon request only when certain conditions are met. Further, for example, after the gateway device 102 is connected via the mobile network 108, it may automatically or manually switch to the fixed network 106 upon request when some other conditions are met. This ensures continuous network connectivity while minimizing use of expensive mobile network traffic.

Depending on the type of the internal network 104, the gateway device 102 and the networked device 112 may be implemented specifically as different entities with different names. For example, the gateway device 102 may be referred to as a wired/wireless gateway, an access point, a router, a modem, a switch, etc. under different network types, while the networked device 112 may be referred to as a terminal, user equipment, etc. Connecting to the external network 110 through the gateway device 102, the networked device 112 may communicate with a networked device 114 in the external network 110. A data packet between the networked device 112 and the networked device 114 may be transferred through the gateway device 102. The networked device 112 and the networked device 114 may each include various mobile devices (e.g., mobile phones, portable computers, portable smart devices, and in-vehicle terminals) and fixed devices (e.g., desktop computers and smart appliances). For example, in a streaming media playback application scenario, the networked device 112 may be a mobile phone requesting to play streaming media, while the networked device 114 may be a server that stores streaming media data.

It should be recognized that the number of gateway devices 102, networked devices 112, and networked devices 114 may be any one or more, and is not limited to the number shown in FIG. 1.

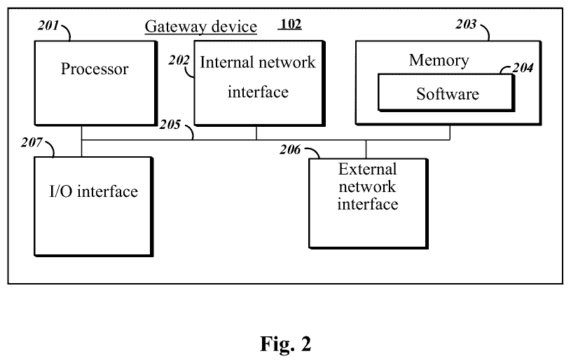

FIG. 2 is a block diagram showing a configuration of a gateway device 102 according to an embodiment of the present disclosure. The gateway device 102 may be any type of device capable of providing network access to an external network for a networked device. As shown in FIG. 2, the gateway device 102 includes a processor 201, an internal network interface 202, a memory 203, a bus 205, and an external network interface 206.

The processor 201 controls general operations of the gateway device 102. The processor 201 may include, but is not limited to, a CPU, a hardware microprocessor, a hardware processor, a multi-core processor, a single-core processor, a microcontroller, an application-specific integrated circuit (ASIC), a DSP, or other similar processing devices, which can execute any type of instructions, algorithms, or software for controlling the operations and functions of the gateway device 102 according to the embodiments described in the present disclosure. The processor 201 may be various implementations of a digital circuit system, an analog circuit system, or a mixed signal (combination of analog and digital) circuit system that executes functions in a computing system. The processor 201 may include, for example, an integrated circuit (IC), a part or circuit of a separate processor core, an entire processor core, an individual processor, a programmable hardware device such as a field programmable gate array (FPGA), and/or a system including a plurality of processors.

The internal network interface 202 may include circuitry implemented in software and/or hardware in order to provide network access to the networked device in the internal network according to wired/wireless protocols. The wired protocol is, for example, the Ethernet protocol. The wireless protocol is, for example, any IEEE 802.11 Wi-Fi protocol, a short-range communication protocol (including Bluetooth protocol, Bluetooth low energy (BLE), RF4CE protocol, ZigBee protocol, Z-Wave protocol, or IEEE 802.15.4 protocol, etc.) that exchanges data over a short range in any licensed or unlicensed frequency band, such as the Citizens Broadband Radio Service (CBRS) frequency band, the 2.4 GHz frequency band, the 5 GHz frequency band, the 6 GHz frequency band, or the 60 GHz frequency band, in accordance with the wireless technology standard. In some embodiments, the internal network interface 202 may include one or a plurality of antennas (not shown) or a circuit node to be coupled to one or a plurality of antennas.

The memory 203 includes one or a plurality of memories or memory locations, including but not limited to a random access memory (RAM), dynamic random access memory (DRAM), static random access memory (SRAM), read-only memory (ROM), EPROM, EEPROM, flash memory, FPGA logic block, hard disk, or any other layers of a memory hierarchy. The memory 203 may be configured to store any type of instructions, software or algorithms, including software 204 for controlling general functions and operations of the gateway device 102.

The internal bus 205 may be used to establish communication between the components (for example, 201-207) of the gateway device 102.

The external network interface 206 may include circuitry implemented in software and/or hardware to enable the gateway device 102 to access various external networks (e.g., a WAN or a mobile communication core network) in accordance with wired and/or wireless protocols. The wired protocol is, for example, the Ethernet protocol. The wireless protocol is, for example, a cellular network communication protocol (e.g., GSM, CDMA 2000, UMTS (WCDMA), LTE, Advanced LTE (LTE-A), LAA/LTE-U, or 5G NR). When using the wired protocol, the gateway device 102 may connect to a fixed network (such as the fixed network 106 in FIG. 1) through the external network interface 206, thereby connecting to the external network. When using the wireless protocol, the gateway device 102 may connect to a mobile network (such as the mobile network 108 in FIG. 1) through the external network interface 206, thereby connecting to the external network.

In some embodiments, the external network interface 206 may include a network interface extended by connecting to peripherals on the gateway device. For example, the gateway device 102 itself may not have an external network interface based on the cellular network communication protocol, but may indirectly implement an external network interface for cellular network communication through an external cellular network adapter.

In some embodiments, the gateway device 102 may further include an I/O interface 207. The I/O interface 207 is a collection of components that can receive input from the user and/or provide output to the user. The I/O interface 207 may include, but is not limited to, buttons, keyboards, keypads, LCD, CRT, TFT, LED, HD, or other similar display devices, including display devices with touch screen capability to enable interaction between users and electronic devices.

Although specific components are used to describe the gateway device 102, in alternative embodiments, different components may exist in the gateway device 102. For example, the gateway device 102 may include one or a plurality of additional processors, memories, internal/external network interfaces and/or I/O interfaces. In addition, one or a plurality of the components may not exist in the gateway device 102. Moreover, in some embodiments, the gateway device 102 may include one or a plurality of components not shown in FIG. 2. In addition, although separate components are shown in FIG. 2, in some embodiments, some or all of the given components may be integrated into one or more of the other components in the gateway device 102. Moreover, any combination of analog and/or digital circuits may be used to realize the circuit and components in the gateway device 102.

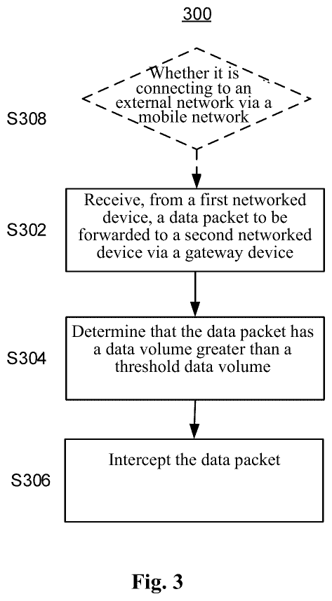

FIG. 3 is an exemplary flowchart of a method 300 for a gateway device according to an embodiment of the present disclosure. For example, this method 300 can be implemented through the gateway device 102 described in FIG. 2, in which, the various steps of the method 300 can, for example, be implemented via the processor 201 of the gateway device 102.

Steps S302, S304, and S306 may be performed during connection of the gateway device to the external network via the mobile network. In some embodiments, the gateway device is connected to the external network only via the mobile network by default, and then steps S302, S304 and S306 will be performed directly during powering-on of the gateway device (i.e., step S308 needs not to be performed). In some other embodiments, the gateway device is initially connected to the external network via the fixed network, and then switches to connect to the external network via the mobile network, and then the gateway device may perform steps S302, S304 and S306 when maintaining the connection via the mobile network after the switching occurs. In this case, the gateway device may determine its own network connection type before performing step S302. In particular, the gateway device may perform step S308 to determine whether it is connecting to the external network via the mobile network. Step S308 is shown in a dashed box, indicating that it is optional. Steps S302-306 are performed again when the determining result of step S308 is “Yes.” In an exemplary implementation of step S308, the gateway device may set a setting flag for the network connection type used. For example, when the gateway device switches to the mobile network for connection, the setting flag is set to 1, and the flag will not change until the gateway device switches back to the fixed network for connection. By checking the setting flag, the gateway device is able to determine whether it is currently connected via the mobile network.

In step S302, the gateway device receives, from the first networked device, a data packet to be forwarded to the second networked device via the gateway device. The first networked device and the second networked device may be respectively located in the internal network where the gateway device is located and the external network to which the gateway device is connected. In some embodiments, the first networked device is located on the internal network and the second networked device is located on the external network. In some other embodiments, the first networked device is located on the external network and the second networked device is located on the internal network. The first networked device and the second networked device may be the networked device 112 and the networked device 114 described in connection with FIG. 1, respectively. Because the gateway device is an essential for the internal network in which it is located to communicate with the external network, data packets sent/received by the first networked device from the second networked device need to be forwarded by the gateway device. The data packets can be subjected to address routing, protocol conversion, etc. at the gateway device. It should be recognized that the gateway device may not receive a data packet directly from the first networked device, but may receive indirectly a data packet from the first networked device via one or more intermediate devices; similarly, the gateway device does not need to directly forward a data packet to the second networked device, but may indirectly forward a data packet to the second networked device via one or more intermediate devices.

In step S304, the gateway device determines that the data packet received in step S302 has a data volume greater than a threshold data volume. The gateway device may perform a packet parsing operation on the received data packet, thereby realizing protocol conversion. In the packet parsing operation, the gateway device may determine a playload section of the data packet; and the gateway device may also determine the size of the data volume of the data packet, including the size of the payload. Therefore, the gateway device is able to filter out data packets with a large data volume, for example, a data volume that is determined to be at or above a threshold data volume. The threshold data volume may be pre-customized based on a specific business scenario of the network. For example, the threshold data volume may be set such that data packets such as audio-video streams are determined to have a larger data volume (a data volume that is at or exceeds a threshold data volume), while data packets for basic text sessions are not determined to have a larger data volume (i.e., to have a data volume that is less than a threshold data volume).

In some embodiments, instead of directly determining whether the data volume for the data packet is greater than the threshold data volume, the gateway device can indirectly determine the data packet with a large data volume by parsing the protocol for the data packet. A group of predefined network protocols may be set in advance, and each network protocol in the protocol group indicates that a data volume transmitted using the network protocol is large, i.e., having a data volume greater than the threshold data volume. In some embodiments, the group of predefined network protocols may be application layer protocols, because the gateway device can work at the application layer, this makes it easier at the application layer to determine whether a service involved in the data packet has a large data volume. In some other embodiments, the group of predefined network protocols may not be limited to application layer protocols, but only need to satisfy that the network protocol can be parsed by the gateway device and can indicate that a corresponding data packet has a large data volume. In some embodiments, the group of predefined network protocols may include, but is not limited to, at least one of: protocols for file transfer (e.g., File Transfer Protocol (FTP) and Trivial File Transfer Protocol (TFTP)), protocols for session establishment (e.g., Session Initiation Protocol (SIP)), Peer to Peer protocols (e.g., Peer to Peer Tunnel Protocol (PPTP)), and application layer streaming protocols. The application layer streaming protocols include, for example, HTTP Live Streaming (HLS), Real-Time Messaging Protocol (RTMP), and Real-Time Streaming Protocol (RTSP). The group of predefined network protocols may also include other currently existing or future developed protocols used to transmit data packets with a large data volume. The user of the gateway device can independently choose which network protocols are listed as involving a large data volume to intercept data packets of the network protocols in subsequent steps. Specifically, during the connection of the gateway device to the external network via the mobile network, when receiving a data packet that needs to be forwarded, the gateway device can parse a header of the data packet to determine the network protocol used to transmit the data packet. The gateway device may then determine whether the network protocol is one of the predefined groups of network protocols. If it belongs to the predefined network protocols, the gateway device may determine that the data packet has a data volume greater than the threshold data volume. However, if it does not belong to the predefined network protocols, the gateway device may determine that the data packet does not have a data volume greater than the threshold data volume.

In some embodiments, instead of directly determining whether the data volume of the data packet is greater than the threshold data volume, the gateway device can also indirectly determine the data packet with a large data volume by parsing a source media access control (MAC) address of the data packet. A MAC address blacklist or a MAC address whitelist may be set in advance. The MAC address blacklist and the MAC address whitelist may be obtained by categorizing MAC addresses of networked devices based on a comparison of data volumes of data packets transmitted by the networked devices with the threshold data volume. Specifically, the MAC address blacklist may include a MAC address of a networked device that typically transmits a data packet with a large data volume. For example, the MAC address blacklist may include a MAC address of a networked device that transmits a data packet with a data volume greater than the threshold data volume. The MAC address whitelist may include a MAC address of a networked device that typically transmits a data packet with a small data volume. For example, the MAC address whitelist may include a MAC address of a networked device that transmits a data packet with a data volume less than the threshold data volume.

As an example, considering an Internet of Things (IoT) network within a wireless local area network (WLAN) scenario for home use, mobile phones, computers, home audio-visual devices, video surveillance devices, smart appliances such as refrigerators, curtains, light bulbs, etc. in the home may be connected to the same gateway device. Some of these devices often transmit a large data volume (for example, mobile phones, computers, home audio-visual devices, and video surveillance devices), while others (for example, some smart appliances) generally transmit a small data volume. When the gateway device is connected via a mobile network, in order to save traffic and reduce bandwidth usage, it may be desirable to intercept networked devices with a large amount of transmitted data, and allow networked devices with a small amount of transmitted data to work properly.

In order to achieve this, the gateway device may record names/identifications and MAC addresses of networked devices when different networked devices are first connected to or each time they are connected to the gateway device. The user can set a MAC address blacklist or a MAC address whitelist by entering or selecting the name/identification and/or MAC address of the networked device. In this way, during the connection of the gateway device to the external network via the mobile network, when receiving a data packet that needs to be forwarded, the gateway device can parse a header of the data packet to determine a source MAC address of the data packet. The gateway device may then determine whether the source MAC address is one of the MAC address blacklists or the MAC address whitelist. If it belongs to the MAC address blacklist, the gateway device can determine that the data packet has a data volume greater than the threshold data volume, thereby intercepting it; and if it does not belong to the MAC address blacklist, the gateway device can determine that the data packet does not have a data volume greater than the threshold data volume, thereby allowing it to pass. Or vice versa, if it belongs to the MAC address whitelist, the gateway device can determine that the data packet does not have a data volume greater than the threshold data volume, thereby allowing it to pass; and if it does not belong to the MAC address whitelist, the gateway device can determine that the data packet has a data volume greater than the threshold data volume, thereby intercepting it.

Next, in step S306, the gateway device intercepts the data packet that is determined to have a data volume greater than the threshold data volume in step 304. Intercepting the data packet includes discarding the data packet without forwarding it to an intended destination address. For a data packet to be forwarded normally, the gateway device can establish a routing table based on its destination address to determine the next hop network address to be sent to; and the gateway device can also perform protocol conversion on the data packet to adapt to the subsequent network. For a data packet determined to be intercepted, the gateway device may set its next hop network address as empty and/or does not perform protocol conversion on the data packet.

In some embodiments, for the network packet received from the first networked device, if the gateway device intercepts it, the gateway device may return a rejection signal to the first networked device. After receiving the rejection signal, the first networked device may stop sending the data packet repeatedly to the gateway device, or even stop sending data packets of the same type (also with a large data volume, or more specifically, using the same network protocol and/or from the same source MAC address), and present prompt information to its users about the transmission failure. Alternatively, after receiving the rejection signal, the first networked device may suspend repeated transmission of the data packet to the gateway device or suspend transmission of the same type of data packets to the gateway device, and present prompt information indicating suspended transmission to its user.

In some embodiments, after the gateway device switches to connecting to the external network via the fixed network, the gateway device may send an allow signal to the first networked device that has been intercepted previously. The allow signal may indicate to the first networked device that the gateway device has switched to connection via the fixed network connection. In response to the allow signal, the first networked device may resume sending the previously intercepted data packet to the gateway device and sending the same type of data packets. In some other embodiments, instead of actively sending the allow signal by the gateway device, the first networked device may repeatedly try to send the intercepted data packet at a certain time interval until the data packet is successfully sent. When the data packet that was previously intercepted is received again, if the gateway device has switched to connect to the fixed network, the gateway device will no longer intercept the data packet, but instead forward the data packet to the original destination network address. Therefore, the gateway device and the first networked device may cooperate to postpone the transmission of the data packet with a large data volume until the gateway device is connected to the fixed network.

In some embodiments, in order to implement step S306, the gateway device may establish a firewall rule. The firewall rule may, for example, be a predetermined action of discarding or rejecting a data packet if the network protocol for the data packet is one of the predefined group of network protocols. This firewall rule may alternatively be, for example, if the source MAC address of the data packet belongs to the MAC address whitelist or the MAC address blacklist, performing a predetermined action on the data packet such as passing (for the whitelist) or discarding or rejecting (for the blacklist). The gateway device performs steps S302 and S304 to trigger execution of the firewall rule.

In some embodiments, the interception function of the gateway device may be enabled by default during connection to the external network via the mobile network. In some other embodiments, the interception function of the gateway device may be enabled or disabled. The gateway device may first determine whether the application layer interception function is enabled. In response to determining that the application layer interception function is enabled, the gateway device performs steps S304 and S306 after step S302. Otherwise, in response to determining that the application layer interception function is disabled, the gateway device may normally forward the received data packet and forgo executing steps S304 and S306. The enabling and/or disabling of the application layer interception function may be responsive to user input. For example, the gateway device may provide a mechanical switch on the gateway device or a switch based on a control on a graphical user interface (GUI) to receive the user input to enable/disable the application layer interception function. FIG. 5 shows an example of enabling/disabling the application layer interception function through a gateway device configuration page 500. The gateway device configuration page 500 may be accessed, for example, by accessing a specific network address at the gateway device or at a networked device within a local area network provided by the gateway device. The user may enable (select “Yes”) or disable (select “No”) the application layer interception function through a switch control 502 in the gateway device configuration page 500.

In some embodiments, the user of the gateway device may also configure a network protocol to be intercepted, that is, the protocol in the predefined group of network protocols. As shown in FIG. 5, after the user enables the application layer interception function through the switch control 502, the gateway device configuration page 500 may also provide a list of network protocols through a switch component 504 for the user to select those that are to be intercepted as in the predefined network protocols.

In some embodiments, the user of the gateway device may also configure the source MAC address to be intercepted or the source MAC address to be allowed for passing, that is, set the MAC address blacklist or MAC address whitelist. FIG. 5 illustrates one example of setting the MAC address blacklist. When the user enables the application layer interception function through the switch control 502, the gateway device configuration page 500 may also allow the user through the control 506 to enter or select a MAC address to be intercepted.

It will be appreciated that the network protocol and MAC address shown in FIG. 5 are merely non-limiting examples. In addition, the enabling/disabling of the application layer interception function, selection of the predefined network protocols, and setting of the MAC address blacklist/MAC address whitelist may alternatively be carried out in different input interfaces.

The user can set the enabling/disabling of the application layer interception function and select the network protocol/source MAC address to be intercepted before the gateway device connects to the external network via the mobile network. This enables the application layer interception function to be automatically enabled/disabled once the gateway device is connected to the mobile network. The user can also set the enabling/disabling of the application layer Interception function and select or change the network protocol to be intercepted at any time while the gateway device is connected to the external network via the mobile network. In the latter case, this setting or modification can take effect immediately.

According to the embodiment of the present disclosure, the gateway device may reduce data packets that transmit a large data volume when connecting via the mobile network, thereby saving bandwidth resources and reducing traffic fees of the mobile network.

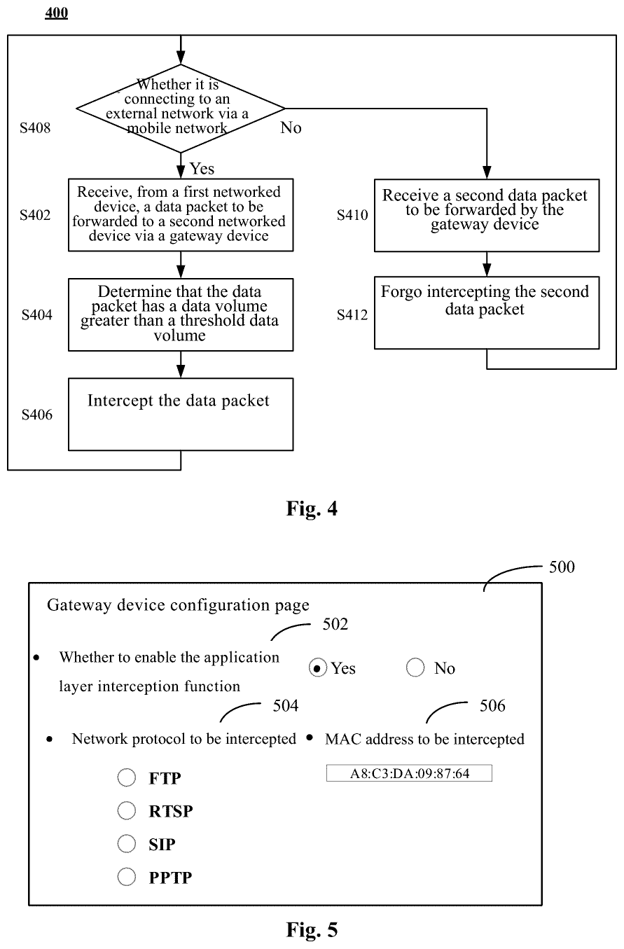

FIG. 4 is an exemplary flowchart of a method 400 for a gateway device according to an embodiment of the present disclosure. The method 400 can be deemed as an extension of the method 300 of FIG. 3, in which, steps S402, S404, and S406 are basically the same as steps S302, S304, and S306 described above with reference to FIG. 3, respectively, so this will not be repeated here. Differences between method 400 and method 300 are introduced below.

The gateway device may switch between connecting to the external network via the fixed network and connecting to the external network via the mobile network. The switching may be in response to the user's indication of the gateway device, or may be automatically performed by the gateway device after detecting that a certain standard is met.

For example, the gateway device that is originally connected via the mobile network may switch to connect to the external network via the fixed network. For another example, the gateway device that is originally connected via the fixed network connection may switch to connect to the external network via the mobile network. The user may instruct the gateway device to perform this switching in various ways. Alternatively, the gateway device can automatically switch to the fixed network when it detects that the mobile network is unavailable or the fixed network is available again, and automatically switch to the mobile network when the fixed network is unavailable.

When changed to connection via the fixed network, the determining result of S408 is “No”, then the gateway device may no longer enable the application layer interception function because the fixed network may provide relatively sufficient bandwidth and the cost is low. In step S410, the gateway device receives a second data packet to be forwarded via the gateway device. The initiator and destination of the second data packet may be the same as or different from those of the first networked device and the second networked device in step S402 (and step S302), respectively. Invariably, the initiator and destination of the second data packet in step S410 are also one in the internal network and the other in the external network. The second data packet may be the same as the data packet in step S402 (i.e. retransmission of the data packet in step S402), or of the same type as the data packet (e.g., using the same network protocol or the same source MAC address), or different from the data packet. For the second data packet, in step S412, the gateway device forgoes intercepting the second data packet. The gateway device can normally perform such processing as routing, forwarding and protocol conversion according to the destination address of the second data packet.

Since the method 400 involves the switching of two connection states (via the fixed network and via the mobile network), it is necessary for the gateway device to confirm the connection state of the gateway device before executing the interception function, especially whether the gateway device is connected via the mobile network. Thus, in method 400, step S408 may be performed to confirm a mobile network connection prior to performing steps S404-S406. Note that the order of steps S402 and S408 may be exchanged without limitation as shown in FIG. 4.

According to the embodiment of the present disclosure, in combination with the switching between the mobile network and the fixed network, the gateway device can maintain a continuous connection to the external network, and at the same time reduce the data packets transmitting a large data volume when connecting via the mobile network, saving bandwidth resources and reducing traffic fees of the mobile network. When the second data packet in step S410 is retransmission of the first data packet, the method 400 may also postpone the transmission of the data packet with a large data volume to be conducted via the fixed network, which can ensure that the data transmission is ultimately completed while reducing the traffic overheads of the mobile network.

The present disclosure may be implemented as any combination of devices, systems, integrated circuits, and computer programs on non-transitory computer-readable media. One or more processors may be enabled as an Integrated Circuit (IC), an Application Specific Integrated Circuit (ASIC) or a Large-scale Integrated Circuit (LSI), a system LSI, a super LSI, or an ultra LSI component that performs part or all of the functions described in the present disclosure.

The present disclosure includes the use of software, applications, computer programs, or algorithms. Software, application programs, computer programs or algorithms may be stored on a non-transitory computer-readable medium, so that a computer with one or a plurality of processors may execute the aforementioned steps and the steps described in the attached drawings. For example, one or a plurality of memories store software or algorithms by executable instructions, and one or a plurality of processors can associate a set of instructions executing these software or algorithms to provide a method for the gateway device to perform data packet interception according to the embodiments described in the present disclosure.

Software and computer programs (also called programs, software applications, applications, components, or codes) comprise machine instructions for programmable processors, and may be realized in high-level procedural languages, object-oriented programming languages, functional programming languages, logic programming languages, or assembly languages or machine languages. The term “computer-readable medium” refers to any computer application product, apparatus or device used to provide machine instructions or data to the programmable data processor, e.g., magnetic disks, optical disks, solid-state storage devices, memories, and programmable logic devices (PLDs), including computer-readable media that receive machine instructions as computer-readable signals.

For example, the computer-readable medium may include the dynamic random access memory (DRAM), random access memory (RAM), read only memory (ROM), electrically erasable read only memory (EEPROM), compact disk read only memory (CD-ROM) or other optical disk storage devices, magnetic disk storage devices or other magnetic storage devices, or any other medium that may be used to carry or store the required computer-readable program codes in the form of instructions or data structures and may be accessed by a general or special computer or a general or special processor. As used herein, magnetic disks or disks include Compact Discs (CDs), laser disks, optical disks, Digital Versatile Discs (DVDs), floppy disks, and Blu-ray disks, in which magnetic disks usually copy data magnetically, and disks copy data optically via laser. Combinations of the above are also included in the scope of computer-readable media.

In addition, the above description provides examples without limiting the scope, applicability, or configuration set forth in the claims. Without departing from the spirit and scope of the present disclosure, changes may be made to the functions and layouts of the discussed elements. Various embodiments may omit, substitute, or add various processes or components as appropriate. For example, features described with respect to some embodiments may be combined in other embodiments.

1. A gateway device, comprising:
a processor; and
a memory coupled to the processor and stored with instructions that, when executed by the processor, cause the gateway device to perform the following operations:
during a connection of the gateway device to an external network via a mobile network:
receiving, from a first networked device, a data packet to be forwarded to a second networked device via the gateway device;
determining that the data packet has a data volume greater than a threshold data volume; and
intercepting the data packet.

2. The gateway device according to claim 1, wherein the instructions further cause the gateway device to perform one of the following operations:
switching the connection of the gateway device to the external network via a fixed network to via the mobile network; or
switching the connection of the gateway device to the external network via the mobile network to via a fixed network.

3. (canceled)

4. The gateway device according to claim 2, wherein the instructions further cause the gateway device to perform the following operations:
during the connection of the gateway device to the external network via the fixed network:
receiving a second data packet to be forwarded via the gateway device; and
forgoing intercepting the second data packet.

5. The gateway device according to claim 2, wherein the instructions further cause the gateway device to perform the following operation:
in response to the gateway device switching the connection of the gateway device to the external network to via the fixed network, sending an allow signal to the first networked device.

6. The gateway device according to claim 1, wherein the determining that the data packet has a data volume greater than a threshold data volume comprises:
parsing a header of the data packet to determine a network protocol used to transmit the data packet; and
determining that the network protocol is one of a predefined group of network protocols, each network protocol of the predefined group of network protocols indicating that a data packet transmitted using the network protocol has a data volume greater than the threshold data volume.

7. The gateway device according to claim 6, wherein the predefined group of network protocols is an application layer protocol.

8. The gateway device according to claim 6, wherein the predefined group of network protocols comprises at least one of: a protocol for file transfer, a protocol for session establishment, a peer-to-peer protocol, or an application layer streaming protocol.

9. The gateway device according to claim 1, wherein the determining that the data packet has a data volume greater than a threshold data volume comprises:
parsing a header of the data packet to determine a source MAC address of the data packet; and
determining that the source MAC address is one of a MAC address blacklist or determining that the source MAC address is not one of a MAC address whitelist, wherein the MAC address blacklist and the MAC address whitelist are obtained by categorizing MAC addresses of networked devices based on a comparison of data volumes of data packets transmitted by the networked devices with the threshold data volume.

10. The gateway device according to claim 1, wherein the determining that the data packet has a data volume greater than a threshold data volume and the intercepting the data packet are performed in response to determining that the gateway device is configured to enable an application layer interception function.

11. The gateway device according to claim 10, wherein the instructions further cause the gateway device to perform the following operation:
configuring the gateway device to enable the application layer interception function in response to user input.

12. The gateway device according to claim 10, wherein the instructions further cause the gateway device to perform the following operation:
in response to determining that the gateway device is configured to disable the application layer interception function, forgoing execution of the determining that the data packet has a data volume greater than a threshold data volume and the intercepting the data packet.

13. The gateway device according to claim 1, wherein the intercepting the data packet comprises:
returning a rejection signal to the first networked device.

14. A method for a gateway device, comprising:
during a connection of the gateway device to an external network via a mobile network:
receiving, from a first networked device, a data packet to be forwarded to a second networked device via the gateway device;
determining that the data packet has a data volume greater than a threshold data volume; and
intercepting the data packet.

15. The method according to claim 14, further comprising one of:
switching the connection of the gateway device to the external network via a fixed network to via the mobile network; or
switching the connection of the gateway device to the external network via the mobile network to via a fixed network.

16. (canceled)

17. The method according to claim 15, further comprising:
during the connection of the gateway device to the external network via the fixed network:
receiving a second data packet to be forwarded via the gateway device; and
forgoing intercepting the second data packet.

18. The method according to claim 14, wherein the determining that the data packet has a data volume greater than a threshold data volume comprises:
parsing a header of the data packet to determine a network protocol used to transmit the data packet; and
determining that the network protocol is one of a predefined group of network protocols, each network protocol of the predefined group of network protocols indicating that a data packet transmitted using the network protocol has a data volume greater than the threshold data volume.

19. The method according to claim 14, wherein the determining that the data packet has a data volume greater than a threshold data volume comprises:
parsing a header of the data packet to determine a source MAC address of the data packet; and
determining that the source MAC address is one of a preset MAC address blacklist or determining that the source MAC address is not one of a preset MAC address whitelist, wherein the MAC address blacklist and the MAC address whitelist are obtained by categorizing MAC addresses of networked devices based on a comparison of data volumes of data packets transmitted by the networked devices with the threshold data volume.

20. The method according to claim 14, wherein at least one of:
the determining that the data packet has a data volume greater than a threshold data volume and the intercepting the data packet are performed in response to determining that the gateway device is configured to enable an application layer interception function; and
the intercepting the data packet comprises returning a rejection signal to the first networked device.

21. The method according to claim 20, further comprising:
configuring the gateway device to enable the application layer interception function in response to user input.

22. (canceled)

23. A non-transitory computer-readable medium for use with a processor of a gateway device, the non-transitory computer-readable medium having instructions stored thereon, wherein when executed by the processor, the instructions cause the gateway device to perform one or more operations:
during a connection of the gateway device to an external network via a mobile network:
receiving, from a first networked device, a data packet to be forwarded to a second networked device via the gateway device;
determining that the data packet has a data volume greater than a threshold data volume; and
intercepting the data packet.

24. (canceled)
